(19) United States
(12) Patent Application Publication
(10) Pub. No.: US 2018/0134365 A1
(43) Pub. Date: May 17, 2018

(54) AIRCRAFT COMPONENT COMPRISING A CHIRAL LATTICE

(71) Applicant: AIRBUS OPERATIONS LIMITED, Bristol (GB)

(72) Inventor: Christian KNIPPRATH, Bristol (GB)

(21) Appl. No.: 15/791,833

(22) Filed: Oct. 24, 2017

(30) Foreign Application Priority Data
Nov. 15, 2016 (GB) 1619293.2

(51) Int. Cl. B64C 1/06; B32B 3/12

(52) U.S. Cl. CPC B64C 1/062; B64D 11/0619; B32B 3/12

(57) ABSTRACT

An aircraft protective component for an aircraft module, the aircraft protective component includes: a plurality of cells connected together to form a lattice, each cell having a chiral structure, wherein the lattice of the cells is configured to at least partially surround the aircraft module to provide an energy absorption barrier for the aircraft module. The aircraft protective component enables the energy generated by an impact to the aircraft to be dissipated throughout the lattice of the protective component. The protective component thus acts as a ‘crumple zone’ to minimize the transfer of such impact energy to the aircraft module.

### RELATED APPLICATION

This application claims priority to United Kingdom Patent Application GB 1619293.2 filed Nov. 15, 2016, the entire contents of each of which is hereby incorporated by reference.

### FIELD OF THE INVENTION

The present invention relates to an aircraft component comprising a chiral lattice, and more particularly to an energy absorption protective component comprising a chiral lattice.

### BACKGROUND OF THE INVENTION

Chiral shapes are defined as being shapes which cannot be mapped onto their mirror image by rotation and/or translation alone. Chiral shapes have been proposed for use in cellular structures as a replacement for traditional honeycomb structures. Such cellular structures are typically auxetic, i.e. they have a negative Poisson's ratio, meaning that they expand laterally when stretched longitudinally.

Airoldi et al. disclosed the idea of incorporating chiral cells into an aircraft wing rib in “Design and Manufacturing of a Composite Rib for a Morphing Wing with a Chiral Topology”, 16th International Conference on Composite Structures (2011).

### SUMMARY OF THE INVENTION

A first aspect of the invention provides an aircraft protective component for an aircraft module, the aircraft protective component comprising: a plurality of cells connected together to form a lattice, each cell comprising a chiral structure, wherein the lattice of cells is configured to at least partially surround the aircraft module to provide an energy absorption barrier for the aircraft module.

This arrangement enables the energy generated by an impact to the aircraft to be dissipated throughout the lattice of the protective component. The protective component thus acts as a ‘crumple zone’ to minimise the transfer of such impact energy to the aircraft module.

The use of chiral lattices in aircraft has until now been restricted to use in structural wing components, where the lattice serves to provide a morphing wing shape. However, the present inventor has established that such lattices can provide a low-weight protective barrier which absorbs and distributes energy transmitted in the event of an aircraft impact.

In preferred embodiments each chiral structure includes: a central node having an axis; and three or more limbs extending from the central node. Each limb may extend from the central node at a position offset from the axis and in a direction generally orthogonal to the axis. One of the three or more limbs of each central node of each chiral structure may be joined to a central node of an adjoining chiral structure, preferably via forming a contiguous joint with a limb of that adjoining chiral structure. The lattice preferably extends in a lattice direction, and the axis of each central node is generally orthogonal to the lattice direction.

Each central node may comprise an elongate member such that its axis extends in a longitudinal direction of the elongate member. Each limb may project from the central node in a tangential direction generally orthogonal to the longitudinal direction. Each limb may comprise a generally ribbon-like member. For each chiral structure, each limb may be joined to the central node such that the generally planar surface of the limb extends in a tangential direction generally orthogonal to the longitudinal direction.

The axis of each central node is preferably generally at an oblique or orthogonal angle to an expected impact direction of the protective component. In this way, an impact to the protective component that imparts a force in the impact direction causes the central nodes of the lattice to move towards one another as the protective component is compressed, this movement of nodes causing a resultant distortion of the connecting limbs and a consequent dissipation of force throughout the protective component.

In preferred embodiments the aircraft module comprises an aircraft cargo bay module and the lattice is configured to be arranged beneath the aircraft cargo bay module. Thus, in the event of an impact to the base of the fuselage caused by an emergency landing or ditching of the aircraft, the impact forces may be distributed throughout the lattice in order to minimise transfer of energy to the cargo bay module. The lattice may be arranged between a lower fuselage panel and the cargo bay module. Previous energy absorption structures in aircraft include struts within the aircraft cargo bay which deform to dissipate energy from an impact in order to protect the cabin space above the cargo bay. However, such struts are not suitable for applications in which the contents of the cargo bay are to be protected. An additional advantage of the energy absorption structure of the present invention is that it is more rigid in bending than existing arrangements. For example, the energy absorption structure may act as a stiffening component of the fuselage.

In such cargo bay embodiments the axis of each central node is preferably configured to be generally orthogonal to a forward-aft aircraft axis. In this way, an impact to the base of the aircraft causes the central nodes of the lattice to more towards one another as the protective component is compressed, this movement of nodes causing a resultant distortion of the connecting limbs and a consequent dissipation of force throughout the protective component.

Alternatively, the axis of each central node may be configured to be generally orthogonal to a forward-aft aircraft axis.

A second aspect of the invention provides an aircraft assembly, comprising: an aircraft module to be protected; and an aircraft protective component according to the first aspect, wherein the lattice of cells is arranged to at least partially surround the aircraft module.

In preferred embodiments, the aircraft module comprises an aircraft cargo bay module and the lattice is arranged between a fuselage lower skin panel and the aircraft cargo bay module.

The aircraft module may comprise a passenger seating module.

A third aspect of the invention provides a method of protecting an aircraft module, comprising: providing an aircraft protective component according to the first aspect; arranging the aircraft protective component so that it at least partially surrounds the aircraft module; and in response to an impact to the aircraft protective component, deforming the lattice to distribute energy from the impact through the lattice.

A further aspect of the invention proposes a method of powering an aircraft systems component, comprising: providing an airframe component comprising a plurality of cells connected together to form a lattice, each cell having a chiral structure; providing one or more piezoelectric transducers fastened to a chiral structure of the aircraft component; in the one or more piezoelectric transducers, converting mechanical strain in the aircraft component into an electric charge; and delivering the electric charge to an aircraft systems component to power that systems component.

In some embodiments the electric charge may be delivered to the aircraft systems component in one or more flight phases, and in one or more other flight phases the electric charge may be analysed to monitor the aircraft component.

Each chiral structure may include: a central node having an axis; and three or more limbs extending from the central node. Each limb may extend from the central node at a position offset from the axis and in a direction generally orthogonal to the axis. One of the three of more limbs of each central node of each chiral structure may be joined to a central node of an adjoining chiral structure.

The airframe component may include a pair of structural members for joining the aircraft component to another aircraft component, and the lattice of cells provides a web extending between the pair of structural members. In some embodiments the web extends in a web direction between the pair of structural members, and the axis of each central node is generally orthogonal to the web direction.

Each structural member of the airframe component may comprise a flange configured to enable attachment of the airframe component to another airframe component. Each flange may be configured to enable attachment of the aircraft component to an upper wing skin panel or lower wing skin panel, respectively.

In preferred embodiments the airframe component comprises a rib of an aircraft wing.

The aircraft systems component is preferably located in a wing of the aircraft, outboard of an aircraft engine.

In a related aspect, the invention proposes an energy generation system for an aircraft, comprising: an airframe component comprising a plurality of cells connected together to form a lattice, each cell having a chiral structure; one or more transducers attached to a chiral structure of the airframe component for converting mechanical strain in the chiral structure into an electric charge; and one or more cables for delivering the electric charge generated by the one or more transducers to either an aircraft systems component to power that aircraft systems component.

In some embodiments the electric charge may be delivered to the aircraft systems component in one or more flight phases, and in one or more other flight phases the electric charge may be analysed to monitor the aircraft component.

Each chiral structure preferably includes: a central node having an axis; and three or more limbs extending from the central node. Each limb may extend from the central node at a position offset from the axis and in a direction generally orthogonal to the axis. One of the three of more limbs of each central node of each chiral structure may be joined to a central node of an adjoining chiral structure.

The airframe component may include a pair of structural members for joining the aircraft component to another aircraft component, and the lattice of cells provides a web extending between the pair of structural members. In some embodiments the web extends in a web direction between the pair of structural members, and the axis of each central node is generally orthogonal to the web direction.

Each structural member of the airframe component may comprise a flange configured to enable attachment of the airframe component to another airframe component. Each flange may be configured to enable attachment of the aircraft component to an upper wing skin panel or lower wing skin panel, respectively.

The airframe component preferably comprises a rib of an aircraft wing.

A further related aspect of the invention provides an aircraft comprising an energy generation system according to the previous aspect.

The aircraft systems component of the aircraft is preferably located in a wing of the aircraft, outboard of an aircraft engine.

Any of the optional, or desirable, features disclosed herein can be applied to any aspect of the invention, either individually or in any combination.

### BRIEF DESCRIPTION OF THE DRAWINGS

Embodiments of the invention will now be described with reference to the accompanying drawings, in which:

FIGS. 1A and 1B illustrate plan and isometric views, respectively, of a chiral cell unit;

FIGS. 2A and 2B illustrate plan and isometric views, respectively, of a chiral lattice;

FIGS. 3A and 3B illustrate a chiral lattice before and after compression;

FIG. 4 shows a section view of two nodes of a chiral cell under in plane loading;

FIG. 5 shows an isometric view of two nodes of a chiral cell under out of plan loading;

FIGS. 6A and 6B show schematic lateral and longitudinal cross-sectional views, respectively, of an aircraft protective component according to an embodiment of the invention;

FIG. 7 shows a front view of an aircraft incorporating an aircraft protective component according to an embodiment of the invention;

FIGS. 8A to 8C illustrate a wing rib incorporating a chiral lattice structure;

FIG. 9 illustrates a wing tip rib incorporating a chiral lattice structure; and

FIG. 10 shows a schematic cross sectional view of a wing with a rib incorporating a chiral lattice structure in deformed and undeformed configurations.

FIGS. 11A and 11B illustrate the distortion of a pair of limbs 120 caused by the above-described distortion of the rib 300 caused by wing bending or other wing loading conditions.

FIG. 12 illustrates the effects of bending/flexing of a transducer with piezoelectric layers.

### DETAILED DESCRIPTION OF EMBODIMENT(S)

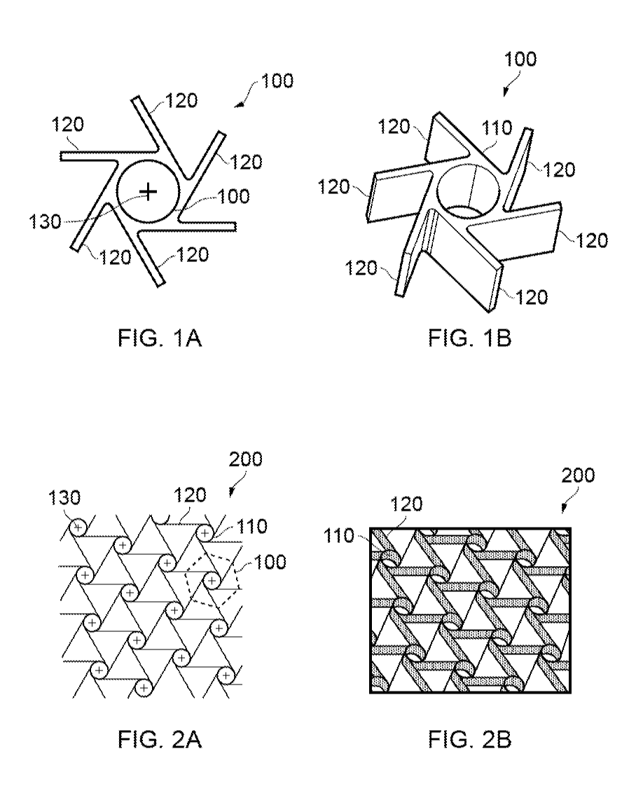

FIGS. 1 and 2 illustrate a chiral unit cell 100 (FIGS. 1A and 1B) and a two-dimensional planar lattice structure 200 formed from an array of such unit cells (FIGS. 2A and 2B). Each chiral cell 100 comprises a central node 110 and six projecting limbs 120.

The central node 110 comprises a hollow tube with a central axis 130. In the illustrated embodiments the tube has a circular cross-sectional shape, but in other embodiments the tube may have any cross-sectional shape such as a polygonal shape. In yet further embodiments the central node may be a solid member, rather than a hollow tube. In all embodiments the central node has a central axis 130 of rotation.

The limbs 120 project from the central node 110 in a direction generally orthogonal to the axis 130 and from a position on the node that is offset from the central axis 130. In this way, the limbs 120 are tangential to the central node 110. The six limbs 120 are evenly distributed around the axis of the central node 110 so that they are equidistant from one another.

Note that in the illustrated embodiment a hexachiral unit cell 100 with six limbs 120 has been described, but any chiral unit with three or more limbs 120 is suitable for use in the invention.

The limbs 120 each comprise a generally planar ribbon-like member connected to the central node 110 such that each limb has a width that corresponds to the length of the central node 110 (in the axial direction). In this embodiment the limbs 120 have a constant width along their lengths, and a constant thickness along their lengths.

The cell units 100 are each interconnected such that each limb 120 of a respective one cell unit 100 is contiguous with a limb of a different neighbouring cell unit 100. The contiguous limbs of neighbouring cell units 100 are integral with one another so that together they form a single elongate generally planar ribbon-like member. In this way, each cell unit 100 is connected to six neighbouring cell units 100 via each of its six projecting limbs 120.

An effect of this arrangement is that the open spaces between neighbouring central nodes 110, and bounded by the limbs 120 of those nodes, are generally triangular in shape and uniformly sized. In embodiments where the cells 100 have fewer, or more, limbs 120 the open spaces will be differently shaped, but in all embodiments the open spaces of the cells are uniform in shape and size.

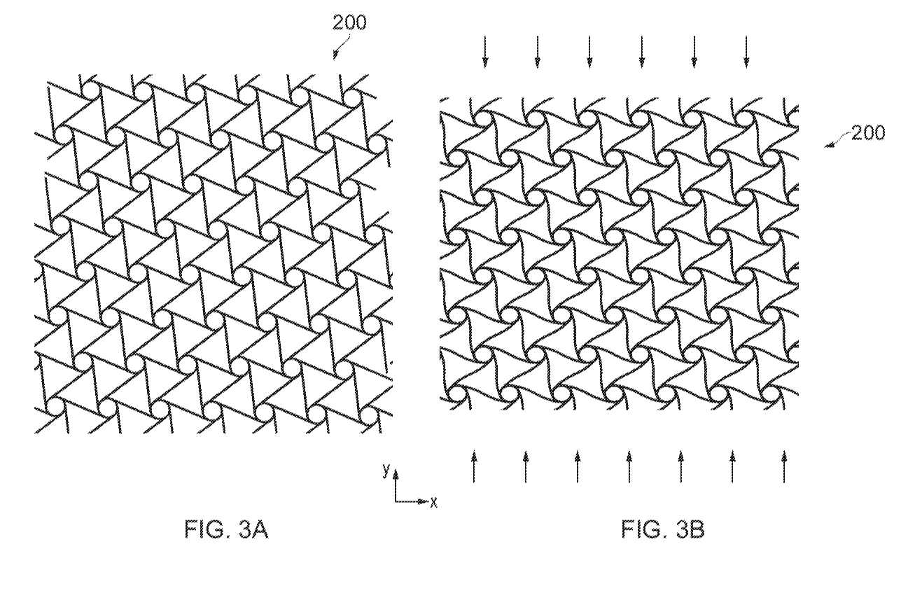

FIGS. 3A and 3B illustrate the negative Poisson's ratio effect of the chiral lattice 200. FIG. 3A shows the lattice in an undeformed condition in which no forces are applied, and FIG. 3B shows the lattice during in-plane compression in the y-direction via compressive forces applied to the top and bottom (as shown in the drawing) edges of the lattice. It can be seen that the lattice is compressed (i.e. reduced in length) in the y-direction, as would be expected. However, rather than expanding in the x-direction as might be expected, the lattice also contracts in the x-direction.

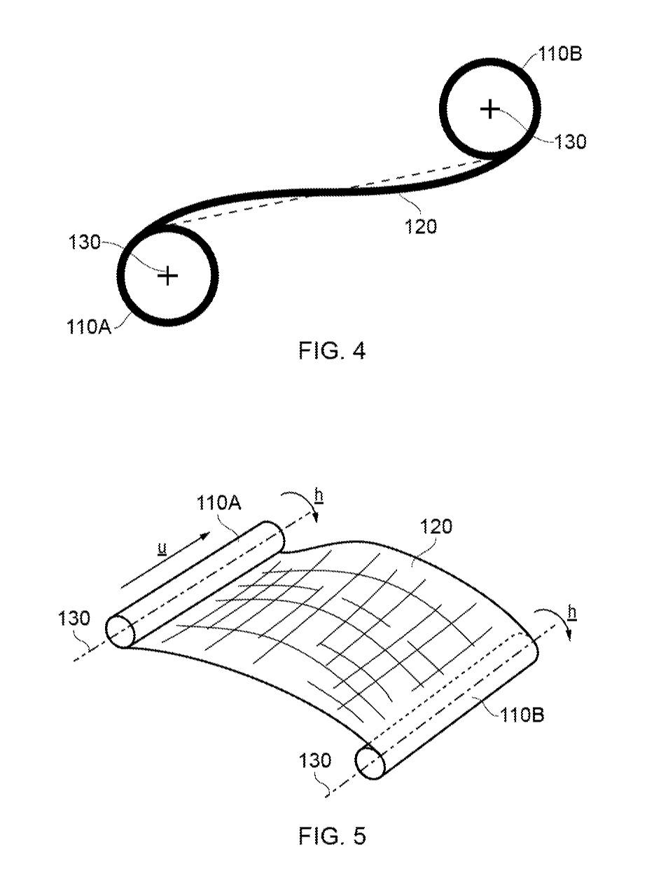

This negative Poisson's ratio effect is achieved via distortion of the connecting limbs 120 of the cells 100. As the compressive force is applied the central nodes 110 are compressed towards one another, causing the nodes 110 to rotate and the limbs 120 to flex so that they are no longer planar but instead form a generally s-shaped curved surface. This is illustrated in FIG. 4, in which just two nodes 110 and one pair of contiguous limbs 120 of the lattice 200 are shown, for clarity. The straight broken line illustrates the neutral (i.e. before any application of force to the lattice) shape of the limbs 120, and the s-shaped solid line indicates the shape of those limbs after application of the compressive force.

This distortion of limbs 120 and rotation of nodes 110 is not localised, but is instead distributed throughout the lattice 200. This ensures that in-plane loads result in a distribution of strains throughout the lattice and a consequent avoidance of undesirable stress concentrations.

A similar effect is seen with out of plane loads, as illustrated in FIG. 5. Like FIG. 4, just two nodes 110A, 110B and one pair of contiguous limbs 120 of the lattice 200 are shown, for clarity. When a displacement u is applied to one of the nodes 110A, the limbs 120 apply a rotation h to the node to cause that node 110A to rotate, and in turn to cause the other of the nodes 110B to rotate under the action of rotation h. To compensate for the twisting of the nodes 110A, 110B, the connecting limbs 120 deform as illustrated in FIG. 5, so that the geometry of the s-shaped cross-section of the limbs 120 varies with distance along the node axis 130.

In this way, out of plane loads result in a distribution of strains throughout the lattice, and consequential minimal stress concentrations.

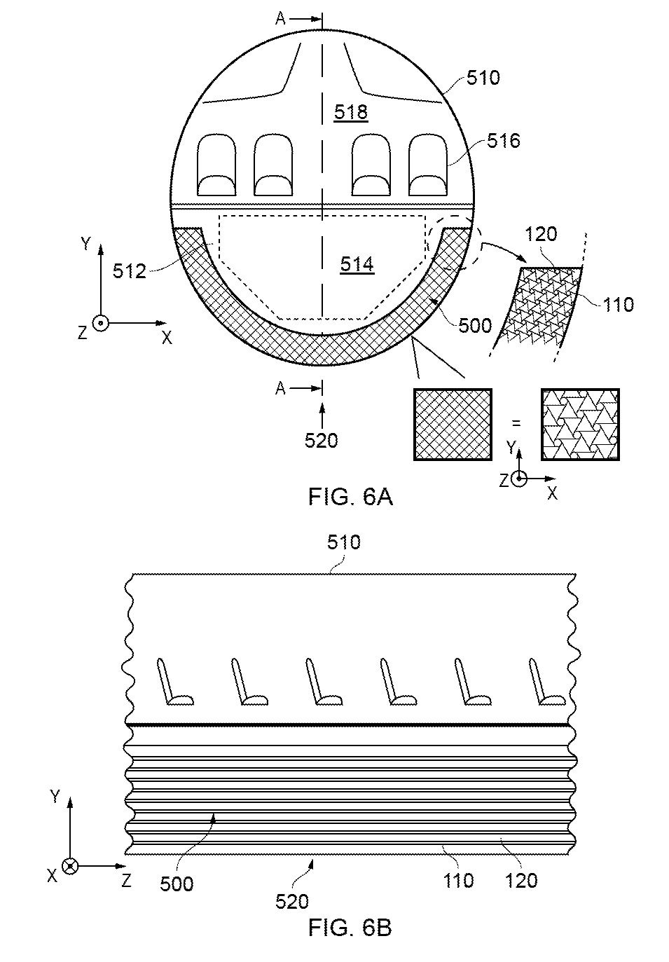

Chiral lattices 200 as discussed above may be used in airframe components. A particularly promising application is in aircraft protective barrier components, such as the energy absorbing barrier 500 illustrated in FIGS. 6A and 6B. This barrier 500 provides a ‘crumple zone’ for the aircraft fuselage 510 to protect the contents of a cargo bay module 512 in the cargo bay 514 in the event that during an emergency landing/ditch attempt the fuselage impacts the ground or water. In some embodiments the cargo bay module 512 may include one or more passenger seats (not shown), similar to the passenger seats 516 in the cabin 518.

As indicated in FIG. 6A, the energy absorbing barrier 500 includes a lattice 200 of chiral cells 100 as described above with relation to FIGS. 1-5. The cells 100 are oriented so that the central node axes 130 are each aligned with the fuselage longitudinal axis (z-axis). Thus, as shown in FIG. 6B, the nodes 110 extend along the fuselage longitudinal axis. The nodes 110 may each provide a continuous elongate member that extends the full length of the portion of the fuselage 510 where the energy absorbing barrier 500 is required, or, more usually, the nodes 110 may be discontinuous along the fuselage longitudinal axis.

In other embodiments the chiral cells 100 may be orientated so that the central node axes are orthogonal to the fuselage longitudinal axis (z-axis).

In the event of an emergency landing as described above, the fuselage 510 impacts the ground/water such that forces in an impact direction 520 are imparted to the fuselage. The impact direction 520 is approximately perpendicular to the fuselage longitudinal axis (z-axis), and thus also approximately perpendicular to the central node axes 130. In this way, the impact forces cause the lattice to distort such that the nodes 110 are compressed towards one another in the fuselage vertical direction (y-axis). This causes the limbs 120 to be distorted as described above in relation to FIGS. 4 and 5.

Thus, the kinetic energy imparted to the fuselage 510 during an impact is distributed throughout the lattice 200 of the energy absorption barrier 500. This has the effect of dissipating the impact energy so that the energy imparted to the cargo bay module 512 is minimised.

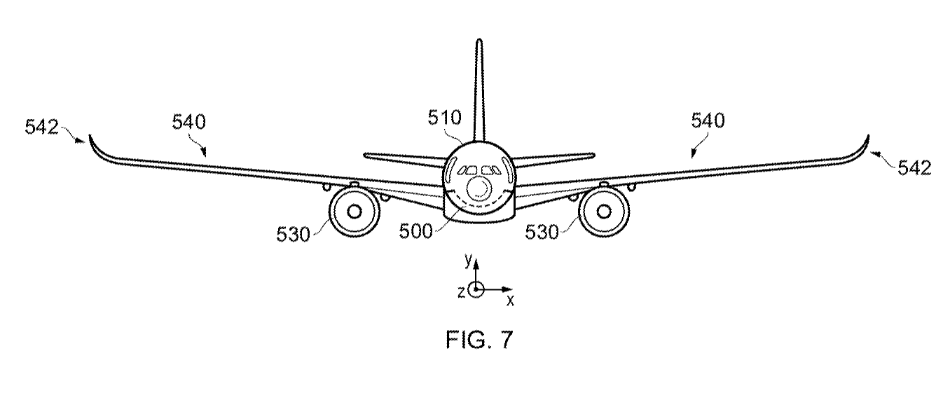

As indicated in FIG. 7, such an energy absorbing barrier 500 may alternatively be employed in other parts of the aircraft, such as to encircle an aircraft engine as part of the engine cowling/nacelle 530, or to provide a protective barrier for an engine systems component (not shown) in the wing 540 or fuselage 510.

Another promising application for chiral lattices 200 is in wing 540 stiffening components such as ribs. A wing rib is a component of the wing box structure which defines the aerofoil shape of the wing, and provides stiffness to the wing box. Another example of an airframe component that may include a chiral lattice is a wing spar.

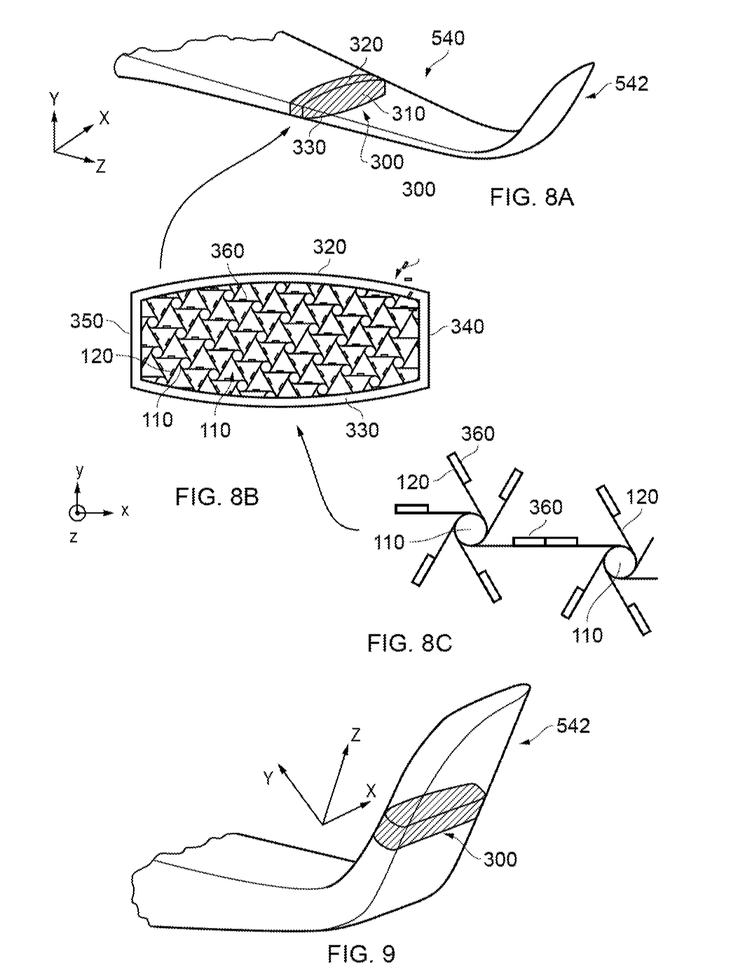

FIGS. 8A-C show a schematic representation of a wing rib 300 with a web 310 comprising a lattice of hexachiral cells 100 as described above. Upper 320 and lower 330 flanges are for attaching the rib to the upper and lower wing skin covers (not shown) of the wing, while forward 340 and rear 350 flanges are for attaching the rib to the forward and rear spars (not shown) of the wing. The rib 300 is located in a dry bay of the wing 540, i.e. a bay that does not carry fuel. Alternatively, the rib 300 may be located in a “wet” bay and have one or more membranes extending across the web 310 to act as fuel tank separators and “sloshing” suppressors.

Each pair of limbs 110 of each chiral cell 100 has a piezoelectric sensor 360 bonded thereto. In some embodiments only some of the limbs 110 may carry a piezoelectric sensor/transducer 360. The piezoelectric sensors/transducers 360 generate electricity as the lattice of chiral cells 100 distort during normal operation of the aircraft, as described further below. The generated electricity is used to power small systems components in the wing 540 or act as a sensing network.

FIG. 9 illustrates a related embodiment in which the rib 300 is located in a wing tip 542 of the wing 540.

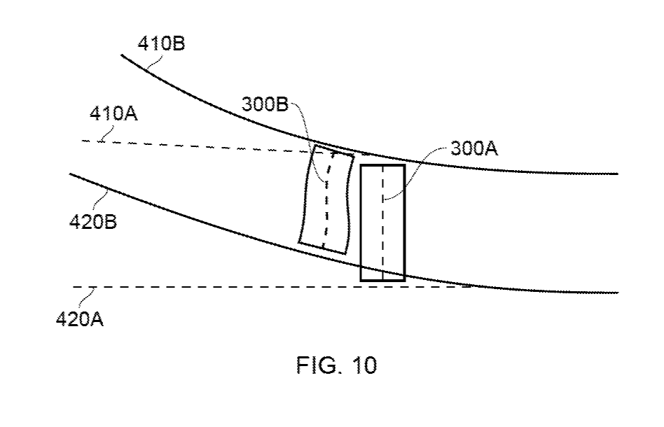

FIG. 10 schematically illustrates the effect of wing bending on the rib 300 of FIGS. 8 and 9. During flight of an aircraft the wings will bend away from their nominal (neutral) position significantly. FIG. 10 illustrates upwards bending, in which the upper wing skin 410B and lower wing skin 420B are deflected away from their nominal positions 410A, 420A, respectively (indicated with broken lines). In the nominal position the rib is indicated by reference 300A, and by reference 300B in the deflected position.

It can be seen that the rib 300B is significantly distorted in an out of plane direction, so that the web 310 develops an s-shaped cross-section. This out of plane loading is accommodated by distortion of the limbs 120, as discussed above.

The inventor has determined that the energy stored in the limbs 120 as they flex in response to wing bending and other loading conditions experienced by the wing can be harvested. Thus, in this embodiment a plurality of limbs 120 of the chiral lattice web 310 of the rib are affixed with a piezoelectric transducer 360 which acts to convert mechanical strain in the chiral structure into an electric charge.

The charge can be used to power small aircraft systems components in the wing, or can be used for wing monitoring purposes. For example, the electric charge may be used to monitor deformation within the rib 300 on ground or during take-off and landing, and/or may be used to generate electricity during flight. To maximise the generated charge, it is desirable to locate the transducers 360 within a rib 300 which experiences relatively large deformations, such as in the outer wing or in the wing tip 542.

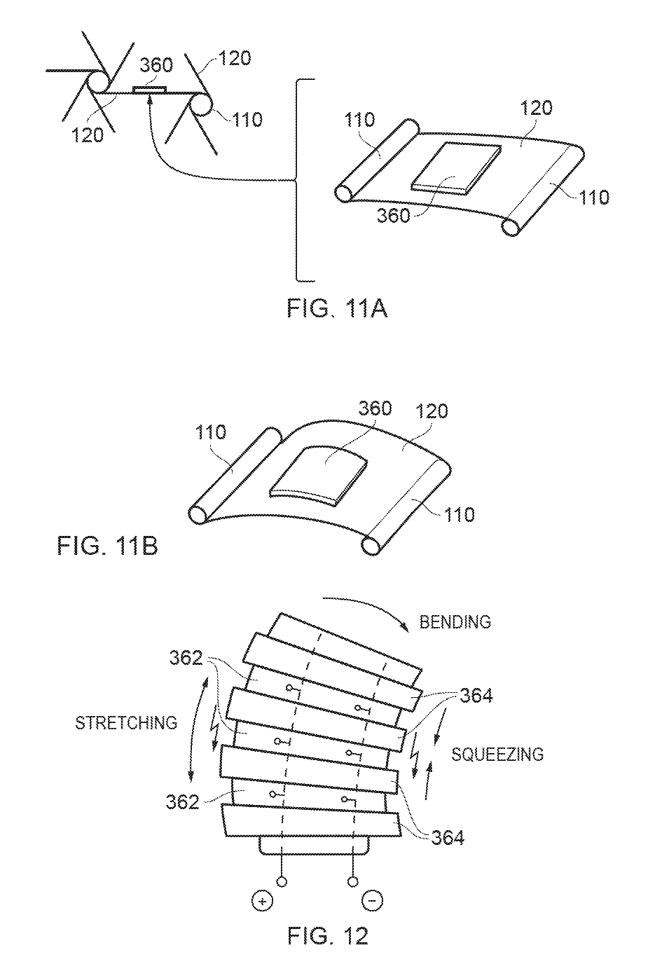

FIGS. 11A and 11B illustrate the distortion of a pair of limbs 120 caused by the above-described distortion of the rib 300 caused by wing bending or other wing loading conditions. It can be seen that the piezoelectric transducer 360 flexes with the limbs 120

A suitable piezoelectric transducer 360 comprises a plate/film with elastomeric piezoelectric toroids. As illustrated in FIG. 12, bending/flexing of the transducer 360 causes each piezoelectric layer 362 to experience compression and extension as it is squeezed or stretched, respectively, by the relatively rigid backing plates 364 within which it is sandwiched. This change in shape acts to generate the electric charge/signal.

Suitable aircraft systems components to be powered by such transducers 360 will typically have low power requirements. The invention may be especially desirable for systems components located outboard of the aircraft engines, since aircraft power distribution units are typically located inboard of the engines and a significant weight saving may be achieved by avoiding routing power cables from these power distribution units to components in the outboard wing. In embodiments in which the transducers 360 are used to provide a sensing network, rather than to generate electrical charge, the generated signals are analysed to determine information about the distortion undergone within the lattice.

Although the invention has been described above with reference to one or more preferred embodiments, it will be appreciated that various changes or modifications may be made without departing from the scope of the invention as defined in the appended claims.

1. An aircraft protective component for an aircraft module, the aircraft protective component comprising:
a plurality of cells connected together to form a lattice, each of the plurality of the cells comprising a chiral structure, wherein the lattice is configured to at least partially surround the aircraft module to provide an energy absorption barrier for the aircraft module.

2. The aircraft protective component according to claim 1, wherein each chiral structure includes:
a central node having an axis; and
three or more limbs extending from the central node.

3. The aircraft protective component according to claim 2, wherein each limb of the three or more limbs extends from the central node at a position offset from the axis and in a direction generally orthogonal to the axis.

4. The aircraft protective component according to claim 2, wherein one of the three or more limbs of each central node of each chiral structure is joined to a central node of an adjoining chiral structure.

5. The aircraft protective component according to claim 2, wherein the lattice extends in a lattice direction, and the axis of each central node is generally orthogonal to the lattice direction.

6. The aircraft protective component according to claim 2, wherein the axis of each central node is generally at an oblique or orthogonal angle to an expected impact direction of the protective component.

7. The aircraft protective component according to claim 1, wherein the aircraft module comprises an aircraft cargo bay module and the lattice is configured to be arranged beneath the aircraft cargo bay module.

8. The aircraft protective component according to claim 7, wherein the axis of each central node is configured to be generally orthogonal to a forward-aft aircraft axis.

9. The aircraft protective component according to claim 7, wherein the axis of each central node is configured to be generally orthogonal to a forward-aft aircraft axis.

10. An aircraft assembly, comprising:
an aircraft module to be protected; and
an aircraft protective component according to claim 1, wherein the lattice is arranged to at least partially surround the aircraft module.

11. The aircraft assembly according to claim 10, wherein the aircraft module comprises an aircraft cargo bay module and the lattice is arranged between a fuselage lower skin panel and the aircraft cargo bay module.

12. The aircraft assembly according to claim 10, wherein the aircraft module comprises a passenger seating module.

13. A method of protecting an aircraft module, comprising:
providing an aircraft protective component comprising cells arranged in a lattice, wherein of the cells each are formed a chiral structure;
arranging the aircraft protective component to at least partially surrounds the aircraft module; and
in response to an impact to the aircraft protective component, deforming the lattice to distribute energy from the impact through the lattice.

14. An aircraft protective component comprising:
cells each having a chiral structure;
a lattice formed by the cells being connected together,
wherein the lattice is shaped to at least partially surround an outer surface of an aircraft module.

15. The aircraft protective component according to claim 14, wherein the chiral structure in each cell includes:
a central node having an axis; and
three or more limbs extending from the central node.

16. The aircraft protective component according to claim 15, wherein each limb of the three or more limbs extends from the central node at a position offset from the axis and in a direction generally orthogonal to the axis.

17. The aircraft protective component according to claim 15, wherein at least one limb of the three or more limbs is joined to a central node of the chiral structure of an adjoining one of the cells.

18. The aircraft protective component according to claim 15, wherein the lattice extends in a lattice direction, and the axis of each central node is orthogonal to the lattice direction.

19. The aircraft protective component according to claim 14, wherein the aircraft module is an aircraft cargo bay module and the lattice is arranged beneath the aircraft cargo bay module.

20. The aircraft protective component according to claim 15 further comprising a piezoelectric transducer or sensor mounted to at least one of the limbs.
